(19) United States
(12) Patent Application Publication
(10) Pub. No.: US 2017/0013702 A1
(43) Pub. Date: Jan. 12, 2017

(54) Electron-Emitter Transformer and High Voltage Multiplier

(71) Applicant: Moxtek, Inc., Orem, UT (US)

(72) Inventors: Gordon Ernest Smith, Sandy, UT (US); Tyler Dean Washburn, Pleasant Grove, UT (US)

(21) Appl. No.: 15/138,794

(22) Filed: Apr. 26, 2016

Related U.S. Application Data
(60) Provisional application No. 62/191,242, filed on Jul. 10, 2015.

(51) Int. Cl. H05G 1/10; H05G 1/32; H01J 35/06; H02M 5/293; H01J 35/08

(52) U.S. Cl. CPC H05G 1/10; H02M 5/293; H01J 35/08; H01J 35/06; H05G 1/32; H02M 2005/2932

(57) ABSTRACT

The invention includes a power supply 17 for an x-ray tube 49. The power supply 17 can comprise a control box 48 and a remote box 47. An electron-emitter transformer 14 can be located in the remote box 47. A box-connector cable 41 between the control box 48 and the remote box 47 can be relatively long and an x-ray tube cable 21 between the remote box 47 and an electron emitter 19 can be relatively short. This design can provide improved electrical power transfer from the power supply 17 to the x-ray tube 49. Also, electrical cable size and cost can be reduced if a high voltage source 15 is located in the remote box 47.

### CLAIM OF PRIORITY

This application claims priority to U.S. Provisional Patent Application No. 62/191,242, filed on Jul. 10, 2015, which is hereby incorporated herein by reference in its entirety.

### FIELD OF THE INVENTION

The present application is related generally to high voltage power supplies for x-ray sources.

### BACKGROUND

A power supply can provide electric power to operate an electron-emitter in an x-ray tube. Feedback from the electric circuit to the power supply can adversely affect power supply operation. It would be beneficial to avoid this undesirable noise in the power supply. Electric power can be lost (I²*R) due to resistance of wires between the power supply and the x-ray tube. It would be beneficial to minimize this power loss. It can be important to reduce x-ray source size and cost, especially for portable x-ray sources.

### SUMMARY

It has been recognized that it would be advantageous to provide more efficient power transfer to the electron-emitter and avoid undesirable noise in the power supply. It has been recognized that it would be advantageous to reduce the size and cost of cables between the power supply and the x-ray tube.

The present invention is directed to various embodiments of an x-ray source and a power supply for an x-ray tube, which satisfy these needs. Each embodiment may satisfy one, some, or all of these needs.

The power supply for the x-ray tube can comprise a control box and a remote box. The control box can be electrically coupled to the remote box by a relatively long box-connector cable. A high voltage source can be configured to provide a bias voltage to an electron-emitter, an anode, or both, in the x-ray tube. The high voltage source can be located in the control box or in the remote box. The control box can include an alternating current (AC) source configured to provide AC for the electron-emitter; an electron-emitter controller configured to control the AC source; and a high voltage controller configured to provide electrical power to operate the high voltage source. The remote box can include an electron-emitter transformer. The electron-emitter transformer can include primary windings and secondary windings. The primary windings can be electrically coupled to the AC source and can be configured to transfer an AC signal from the AC source to the secondary windings. The secondary windings can be configured to be electrically coupled across the electron-emitter.

The x-ray source can include a power supply, similar to that just described, plus an x-ray tube including (1) a cathode and an anode, electrically insulated from each other; (2) the cathode including an electron-emitter capable of emitting electrons towards the anode; and (3) the anode capable of emitting x-rays in response to impinging electrons from the electron-emitter.

### BRIEF DESCRIPTION OF THE DRAWINGS (DRAWINGS MIGHT NOT BE DRAWN TO SCALE)

FIG. 1 is a schematic view of an x-ray source with a long x-ray tube cable 21 between an electron-emitter transformer 14 and an electron emitter 19.

FIG. 2 is a graph showing ideal voltage at the electron-emitter transformer.

FIG. 3 is a graph showing non-ideal voltage at the electron-emitter transformer.

FIG. 4 is a schematic of an x-ray source 40, including a control box 48, a remote box 47, and an x-ray tube 49, in accordance with an embodiment of the present invention.

FIG. 5 is a schematic of an x-ray source 50, including a DC bias cable 18 extending from the control box 48 to the remote box 47, in accordance with an embodiment of the present invention.

FIG. 6 is a schematic of an x-ray source 60, including a high voltage source configured to provide a bias voltage to an anode 43 in the x-ray tube 49, in accordance with an embodiment of the present invention.

FIG. 7 is a schematic of an x-ray source 70, including a high voltage source configured to provide a bias voltage to an electron-emitter 11 and to an anode 43 in the x-ray tube 49, in accordance with an embodiment of the present invention.

FIG. 8 is a schematic of an x-ray source 80, including a second transformer 64 electrically coupled between the electron-emitter transformer 14 and the AC source 22, in accordance with an embodiment of the present invention.

FIG. 9 is a schematic of an x-ray source 90, wherein the high voltage source 15 is located in the remote box 47, in accordance with an embodiment of the present invention.

### DETAILED DESCRIPTION

Wires or cables can be used to transfer alternating current (AC). If short cables transfer AC, then the cables are regarded merely as conductors, and the cables have minimal effect on the circuit except for transfer of electrical current. If long cables transfer AC, then the cables are regarded as a transmission line and distributed inductance and distributed capacitance of the cables can affect the electrical circuit. Generally, cables are considered to be long if the cable is longer than one fourth of a wavelength of the AC signal.

If a transmission line is terminated by a load with impedance equal to the characteristic impedance of the transmission line, then no power is reflected back to the electrical power source and there can be maximum transfer of power to the load. If, however, the load impedance does not equal the characteristic impedance, then electrical power will be at least partially reflected back to the electrical power source, resulting in inefficient transfer of power and possibly undesirable noise in the power supply.

Shown in FIG. 1 is an x-ray source 10, including a power supply 17 which can supply AC to an electron-emitter 19, such as for example a filament of an x-ray tube. An electron-emitter controller 11 can open or close MOSFETs 13a and 13b to allow AC to flow through primary windings on electron-emitter transformer 14 and between a direct current (DC) source 12 and ground 23.

A high voltage controller 16 can provide electrical power (e.g. AC) to a high voltage source 15. The high voltage source 15 can then provide a large negative bias voltage (e.g. ≦−4 kV) to the electron-emitter 19. The high voltage source 15 can be a high voltage multiplier, such as for example, a Cockcroft-Walton multiplier.

In one application using x-ray source 10, the AC signal wavelength is 4000 meters. X-ray source 10 users desire a distance between the power supply 17 and the electron-emitter 19 of about 2-5 meters to position the x-ray tube in a very small space where the power supply 17 cannot fit. Thus, these users desire an x-ray tube cable 21 (cable between the electron-emitter transformer 14 and the electron emitter 19) with a length L₁ of about 2-5 meters. The longest desired x-ray tube cable 21 is less than ¼ of the AC signal wavelength (1/4*4000 m=1000 m), so it appears that the x-ray tube cable 21 can be treated as a short cable, i.e. merely as a conductor and not as a transmission line.

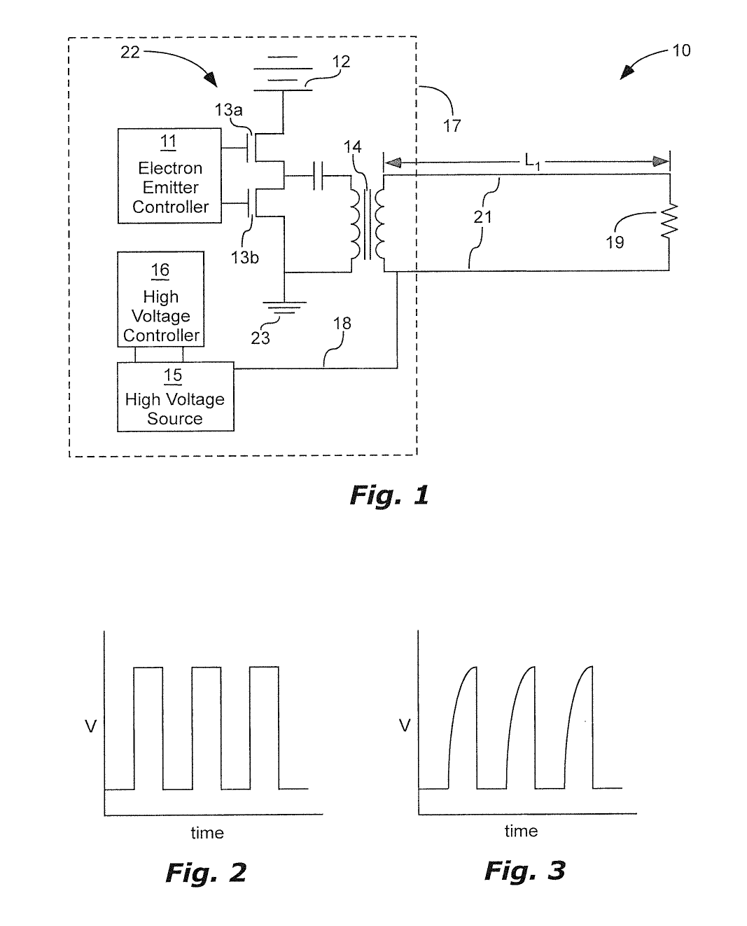

The desired waveform of the voltage through electron-emitter transformer 14 is the square waveform shown in FIG. 2. The actual waveform measured, however, is the curved waveform shown in FIG. 3. Experimentation shows that the x-ray tube cable 21 is acting as a transmission line, even though the x-ray tube cable 21 is “short” based on traditional theory. Power is reflected from the electron-emitter 19 to the power supply 17, resulting in inefficient power transfer to the electron-emitter 19 and undesirable noise in the power supply 17.

A cause of the relatively short x-ray tube cable 21 acting as a transmission line is believed to be the AC source design. The AC source 22 design, which is useful for portable x-ray sources, causes a change of the transition point from cable to transmission line. Lowering the frequency of the AC signal can extend this transition point further out, and possibly allow the use of cables with a length up to or greater than the desired 5 meters, but lowering the frequency can cause inefficient operation of the electron-emitter transformer 14. Matching the electron-emitter 19 impedance with the characteristic impedance of the x-ray tube cable 21 can allow efficient transfer of AC, but such matching is not practical in this circuit (electron-emitter 19 design is set based on desired x-ray emission). Thus, another solution is desired for efficient power transfer to the electron-emitter 19 without undesirable noise in the power supply 17.

Another problem of x-ray source 10 is electrical power loss in the x-ray tube cable 21. A high electrical current may be needed for the electron-emitter 19 (e.g. to heat filaments). Electrical power loss due to this high electrical current can result in high power losses (P=I²*R).

An additional problem of x-ray source 10 is size and cost of the x-ray tube cable 21. This problem is more troublesome if the x-ray source 10 has a relatively high bias voltage and/or a relatively long x-ray tube cable 21.

Illustrated in FIGS. 4-9 are x-ray sources 40, 50, 60, 70, 80, and 90 which provide solutions for undesirable noise in the power supply 17, excessive electrical power loss in x-ray source 10, and electrical power cable size and cost. Each embodiment may satisfy one, some, or all of these needs.

The x-ray sources 40, 50, 60, 70, 80, and 90 can include a power supply 17 and an x-ray tube 49. The x-ray sources 40, 50, 60, 70, 80, and 90 can be battery-operated (i.e. a battery supplies electric power to the power supply) and can be portable. The x-ray tubes 49 shown in the figures are transmission-target type, but the invention herein is applicable also to side-window x-ray tubes.

The power supply 17 can include a control box 48 and a remote box 47. The control box 48 can be electrically coupled to the remote box 47 by a box-connector cable 41. The box-connector cable 41 can include a connector 46 to allow connection and disconnection of the remote box 47 to the control box 48. The box-connector cable 41 can provide electrical power for an electron-emitter 19 and also can include a ground cable (not shown).

The remote box 47 can be electrically coupled to the x-ray tube 49 by an x-ray tube cable 21. The x-ray tube cable 21 can include a connector 38 to allow connection and disconnection of the remote box 47 to the x-ray tube 49. The x-ray tube cable 21 can also include a ground cable (not shown).

The x-ray tube 49 can include a cathode 42 and an anode 43 which can be electrically insulated from each other (e.g. by an electrically insulative enclosure 39). The cathode 42 can include an electron-emitter 19 which can emit electrons 45 towards the anode 43. The anode 43 can emit x-rays 44 in response to impinging electrons 45 from the electron-emitter 19.

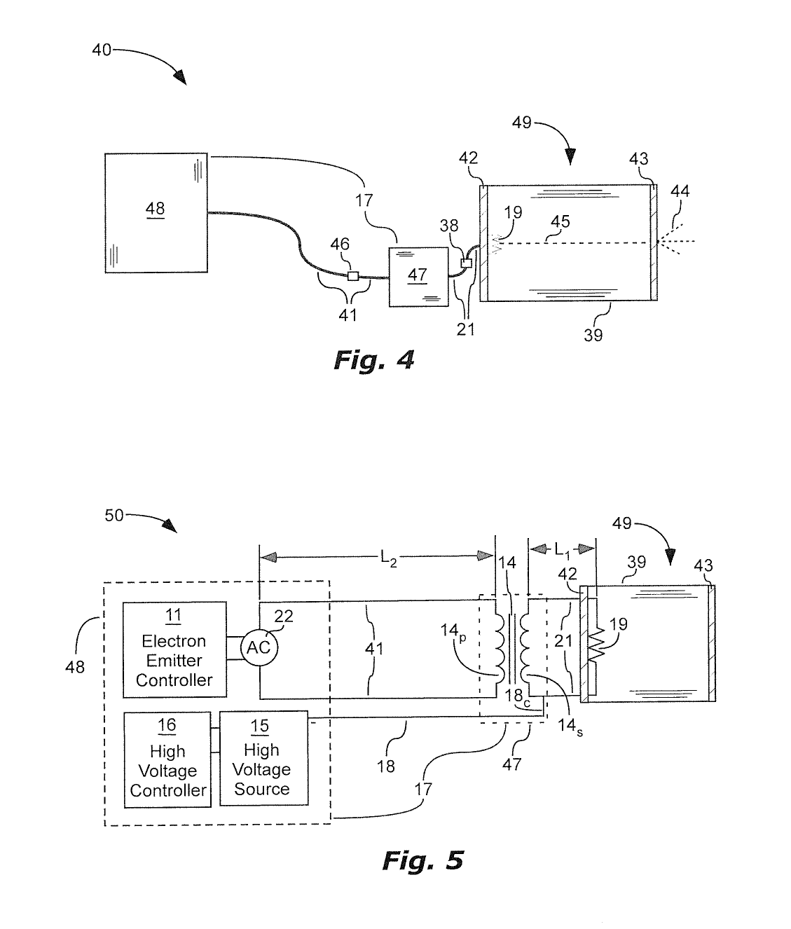

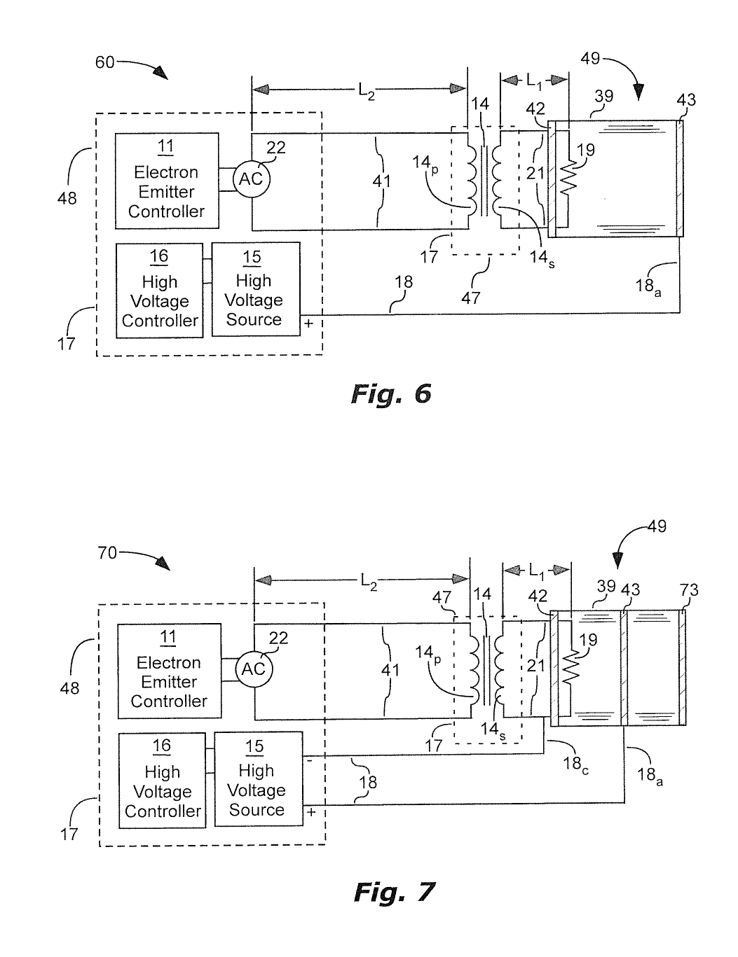

A high voltage source 15 can be located in the control box 48 (see FIGS. 5-8) or in the remote box 47 (see FIG. 9). The high voltage source 15 can provide a large bias voltage (e.g. several kilovolts). For example, the high voltage source 15 can be a high voltage multiplier, such as a Cockcroft-Walton multiplier. The high voltage source 15 can (e.g. by number of stages of capacitors and diodes in a Cockcroft-Walton multiplier plus amplitude of input AC signal) be configured to provide a certain voltage.

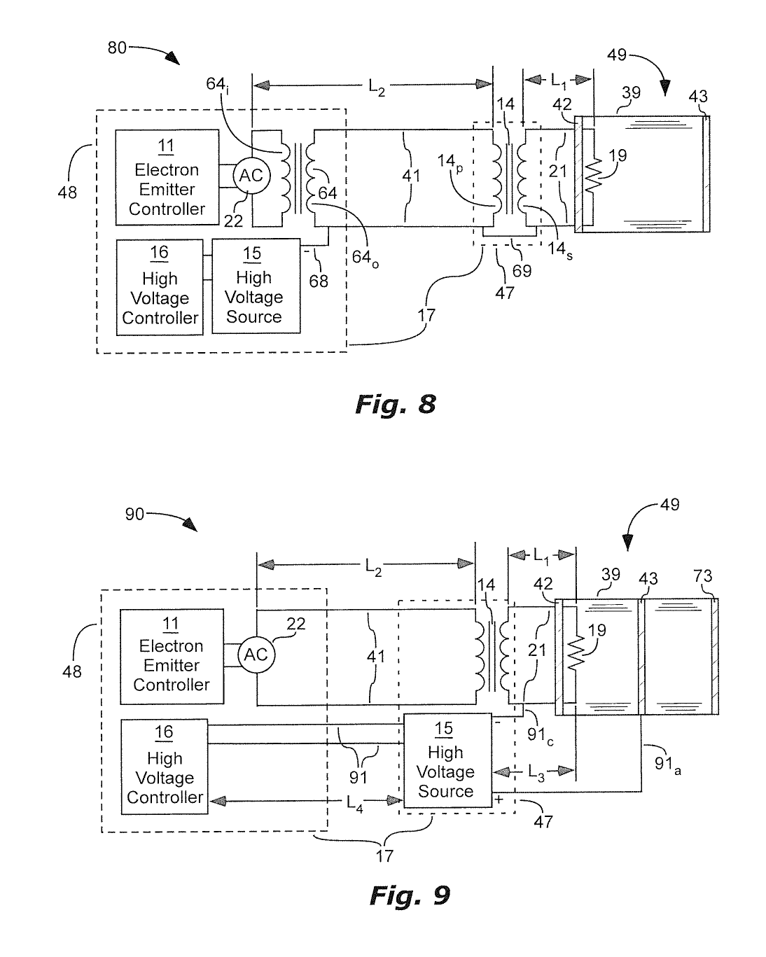

The high voltage source 15 can provide a large negative bias voltage to the electron-emitter 19 (see FIGS. 5 and 8). The large negative bias voltage can be ≦−1 kilovolt in one aspect (e.g. −2 kV, −3 kV . . . ), ≦−4 kilovolts in another aspect, or ≦−10 kilovolts in another aspect. The anode 43 can be maintained at or near ground voltage.

The high voltage source 15 can provide a large positive bias voltage to the anode 43 (see FIG. 6). The large positive bias voltage can be ≧1 kilovolt in one aspect (e.g. 2 kV, 3 kV . . . ), ≧4 kilovolts in another aspect, or ≧10 kilovolts in another aspect. The cathode 42 can be maintained at or near ground voltage.

The high voltage source 15 can provide a large negative bias voltage to the electron-emitter 19 and a large positive bias voltage to the anode 43 (see FIGS. 7 and 9). A second x-ray window 73 can be maintained at or near ground voltage.

The control box 48 can include an AC source 22 for the electron-emitter 19, an electron-emitter controller 11, and a high voltage controller 16. In some designs, the control box 48 can also include the high voltage source 15 (see FIGS. 5-8). The electron-emitter controller 11 can be configured to control the AC source 22. The electron-emitter controller 11 can control the AC source 22 by providing appropriate electrical power. The AC source 22 can be a switching MOSFET type as shown in FIG. 1, or other type of AC source. For the design shown in FIG. 1, the electron-emitter controller 11 can open and close the MOSFETs to provide the desired frequency of AC.

The high voltage controller 16 can provide electrical power to operate the high voltage source 15. For example, if the high voltage source 15 is a Cockcroft-Walton multiplier, then the high voltage controller 16 can provide AC, at a desired amplitude and frequency, to the high voltage source 15, to obtain the desired output DC bias voltage.

The remote box 47 can include an electron-emitter transformer 14. In some designs, the remote box 47 can also include the high voltage source 15, as shown in FIG. 9, and described in more detail below. The electron-emitter transformer 14 can include a core wrapped with primary windings 14ₚ and secondary windings 14ₛ. The primary windings 14ₚ can be electrically coupled to the AC source 22 (directly or through additional transformer(s)). The primary windings 14ₚ can be configured to transfer an AC signal from the AC source 22 to the secondary windings 14ₛ (e.g. by inducing a changing magnetic field in the core, which then induces alternating current in the secondary windings 14ₛ). The electron-emitter 19 can be electrically coupled across the secondary windings 14ₛ.

In the design shown in FIG. 1, there can be a very short distance (e.g. less than a few centimeters) between the AC source 22 and the electron-emitter transformer 14. In contrast, as shown in FIGS. 4-9, the box-connector cable 41 can be relatively long, such as for example with a length L₂ of at least 0.6 meters in one aspect, at least 1 meter in another aspect, at least 2 meters in another aspect, at least 4 meters in another aspect, at least 8 meters in another aspect, at least 15 meters in another aspect, or at least 30 meters in another aspect. Thus, there can be a length of at least 0.6, 1, 2, 4, 8, 15, or 30 meters between the AC source 22 and the electron-emitter transformer 14 in embodiments of the present invention.

The relatively long box-connector cable 41 can allow the x-ray source user to locate the x-ray tube 49 in remote locations. The remote box 47 can be small enough to fit into small locations with the x-ray tube 49 because the remote box 47 might only contain the electron-emitter transformer 14 and possibly also the high voltage source 15. A size of the remote box 47 can be less than 50 cm³ in one aspect, less than 20 cm³ in another aspect, less than 10 cm³ in another aspect, or less than 5 cm³ in another aspect.

The x-ray tube cable 21 can be relatively short. For example, the x-ray tube cable 21 can have a length of less than 0.75 meters in one aspect, less than 0.5 meters in another aspect, or less than 0.25 meters in another aspect.

It can be relatively easy to substantially match a characteristic impedance of the box-connector cable 41 to the load seen at the electron-emitter transformer 14 by adjusting the turns of the primary windings 14ₚ, but it can be more difficult or impractical to match characteristic impedance of the x-ray tube cable 21 to the electron emitter 19. Thus, there can be efficient electrical power transfer from the control box 48 to the remote box 47 without undesirable noise by matching or approximately matching the characteristic impedance of the box-connector cable 41 to the load seen at the electron-emitter transformer 14. There can be efficient electrical power transfer from the remote box 47 to the x-ray tube 49, even if characteristic impedance of the x-ray tube cable 21 does not match impedance of the electron-emitter 19, because the x-ray tube cable 21 can be relatively short.

A high turn ratio of primary windings 14ₚ to secondary windings 14ₛ on the electron-emitter transformer 14 can also improve electrical power transfer. AC can be transferred on the relatively long box-connector cable 41 at a higher voltage in order to reduce power loss, then stepped down at the electron-emitter transformer 14 for transfer of electrical power through the possibly short x-ray tube cable 21 to the electron-emitter 19. For example, a turn ratio of primary windings 14ₚ to secondary windings 14ₛ on the electron-emitter transformer 14 can be: ≧2:1 in one aspect or ≧4:1 in another aspect and can be ≦10:1 in one aspect or ≦20:1 in another aspect.

As shown in FIGS. 5-7, with the high voltage source 15 located in the control box 48, a DC bias cable 18 can provide DC bias to the electron emitter (see cable 18_{c} in FIG. 5), to the anode 43 (see cable 18ₐ in FIG. 6), or both (see cable 18_{c} and cable 18ₐ in FIG. 7). The DC bias cable 18 can extend from the control box 48 to the remote box 47 or from the control box 48 to the x-ray tube 49. The DC bias cable 18 can be about the same length L₂ as, or longer than, the box-connector cable 41 (e.g. at least 0.6, 1, 2, 4, 8, 15, or 30 meters).

As shown in FIG. 8, a second transformer 64 can be electrically coupled between the electron-emitter transformer 14 and the AC source 22. The second transformer 64 can include input windings 64ᵢ and output windings 64ₒ. The input windings 64ᵢ can be electrically coupled to the AC source 22 and configured to transfer an AC signal from the AC source 22 to the output windings 64ₒ. The output windings 64ₒ can be electrically coupled to the primary windings 14ₚ of the electron-emitter transformer 14.

A first bias wire 68 can electrically couple the high voltage source 15 and the output windings 64ₒ to provide the negative bias voltage to the output windings 64ₒ. The first bias wire 68 can be short (e.g. less than 5 centimeters) and can be located entirely within the control box 48. A second bias wire 69 can electrically couple the primary windings 14ₚ and the secondary windings 14ₛ to transfer the negative bias voltage from the primary windings 14ₚ to the secondary windings 14ₛ. The second bias wire 69 can be short (e.g. less than 5 centimeters) and can be located entirely within the remote box 47.

An advantage of x-ray sources 50, 60, and 70 over x-ray source 80 is only one transformer between the electron-emitter 19 and the AC source 22. A disadvantage of x-ray sources 50, 60, and 70 in comparison to x-ray source 80 is that the DC bias cable 18 in x-ray sources 50, 60, and 70 can be larger and more expensive. The advantages of each design can be compared for each use.

As shown on x-ray source 90 in FIG. 9, the high voltage source 15 can be located in the remote box 47. High voltage controller cables 91 can carry electrical power to the high voltage source 15 in the remote box 47. The amplitude of the AC carried by the high voltage controller cables 91 can be much less than the magnitude of the DC bias voltage, so less insulation can be used on the high voltage controller cables 91 than on the DC bias cable 18 shown in FIG. 5. Thus, cable size and expense can be reduced. A cable 91_{c} can transfer a negative bias voltage from the high voltage source 15 to the electron-emitter 19, a cable 91ₐ can transfer a positive bias voltage from the high voltage source 15 to the anode 43, or both.

1. An x-ray source comprising:
a. an x-ray tube including:
i. a cathode and an anode, electrically insulated from each other;
ii. the cathode including an electron-emitter capable of emitting electrons towards the anode;
iii. the anode capable of emitting x-rays in response to impinging electrons from the electron-emitter;
b. a power supply including a control box electrically coupled to a remote box by a box-connector cable having a length of at least 1 meter;
c. a high voltage source configured to provide a bias voltage to the electron-emitter, the anode, or both, the high voltage source located in the remote box;
d. the control box including:
i. an alternating current (AC) source for the electron-emitter;
ii. an electron-emitter controller configured to control the AC source;
iii. a high voltage controller configured to provide electrical power to operate the high voltage source;
e. the remote box including an electron-emitter transformer, the electron-emitter transformer comprising:
i. primary windings and secondary windings;
ii, the primary windings electrically coupled to the AC source and configured to transfer an AC signal from the AC source to the secondary windings; and
f. the electron-emitter electrically coupled across the secondary windings.

2. The x-ray source of claim 1, wherein the box-connector cable has a length of at least 2 meters.

3. The x-ray source of claim 1, wherein the box-connector cable has a length of at least 8 meters.

4. The x-ray source of claim 1, wherein the box-connector cable includes a connector to allow connection and disconnection of the remote box to the control box.

5. The x-ray source of claim 1, further comprising an x-ray tube cable that electrically couples the remote box to the x-ray tube and wherein the x-ray tube cable has a length of less than 0.75 meters.

6. The x-ray source of claim 5, wherein the x-ray tube cable includes a connector to allow connection and disconnection of the remote box to the x-ray tube.

7-9. (canceled)

10. The x-ray source of claim 1, wherein a turn ratio of primary windings to secondary windings on the electron-emitter transformer is: ≧2:1 and ≦10:1.

11. A power supply for an x-ray tube, the power supply comprising:
a. a control box and a remote box;
b. the control box electrically coupled to the remote box by a box-connector cable having a length of at least 1 meter;
c. a high voltage source:
i. configured to provide a bias voltage of:
<−1 kilovolt to an electron-emitter in the x-ray tube;
>1 kilovolt to an anode in the x-ray tube; or
both;
ii. the high voltage source located in the control box or in the remote box;
d. the control box including:
i. an alternating current (AC) source configured to provide AC for the electron-emitter;
ii. an electron-emitter controller configured to control the AC source;
iii. a high voltage controller configured to provide electrical power to operate the high voltage source; and
e. the remote box including an electron-emitter transformer, the electron-emitter transformer comprising:
i. primary windings and secondary windings;
ii. the primary windings electrically coupled to the AC source and configured to transfer an AC signal from the AC source to the secondary windings;
iii. the secondary windings configured to be electrically coupled across the electron-emitter.

12. The x-ray source of claim 11, wherein the box-connector cable has a length of at least 2 meters.

13. The x-ray source of claim 11, wherein the box-connector cable has a length of at least 8 meters.

14. The x-ray source of claim 11, wherein the box-connector cable includes a connector to allow connection and disconnection of the remote box to the control box.

15. The x-ray source of claim 11, wherein a turn ratio of primary windings to secondary windings on the electron-emitter transformer is: ≧2:1 and ≦10:1.

16. The x-ray source of claim 11, wherein the high voltage source is located in the remote box.

17. A power supply for an x-ray tube, the power supply comprising:
a. a control box and a remote box;
b. the control box electrically coupled to the remote box by a box-connector cable having a length of at least 1 meter;
c. the control box including:
i. a high voltage source configured to provide a bias voltage of:
<−1 kilovolt to an electron-emitter in the x-ray tube;
>1 kilovolt to an anode in the x-ray tube; or
both;
ii. an alternating current (AC) source configured to provide AC for the electron-emitter;
iii. an electron-emitter controller configured to control the AC source;
iv. a high voltage controller configured to provide electrical power to operate the high voltage source;
d. the remote box including an electron-emitter transformer, the electron-emitter transformer comprising:
i. primary windings and secondary windings;
ii. the primary windings electrically coupled to the AC source and configured to transfer an AC signal from the AC source to the secondary windings;
iii. the secondary windings configured to be electrically coupled across the electron-emitter;
e. a second transformer electrically coupled between the electron-emitter transformer and the AC source, the second transformer including:
i. input windings and output windings;
ii. the input windings electrically coupled to the AC source and configured to transfer an AC signal from the AC source to the output windings;
iii. the output windings electrically coupled to the primary windings of the electron-emitter transformer;
f. a first bias wire electrically coupled between the high voltage source and the output windings to provide the bias voltage to the output windings; and
g. a second bias wire electrically coupled between the primary windings and the secondary windings to transfer the bias voltage from the primary windings to the secondary windings.

18. The x-ray source of claim 17, wherein the box-connector cable has a length of at least 4 meters.

19. The x-ray source of claim 17, wherein a turn ratio of primary windings to secondary windings on the electron-emitter transformer is: ≧2:1 and ≦10:1.

20. The x-ray source of claim 17, further comprising an x-ray tube cable that electrically couples the remote box to the x-ray tube and wherein the x-ray tube cable has a length of less than 0.75 meters.

21. The x-ray source of claim 17, wherein the second bias wire is located entirely within the remote box.

22. The x-ray source of claim 17, wherein the box-connector cable has a length of at least 8 meters.

23. The x-ray source of claim 17, wherein the box-connector cable includes a connector to allow connection and disconnection of the remote box to the control box.
